(19) United States
(12) Patent Application Publication
(10) Pub. No.: US 2018/0111326 A1
(43) Pub. Date: Apr. 26, 2018

(54) Vehicle Assembly System

(71) Applicant: Atieva, Inc., Menlo Park, CA (US)

(72) Inventor: Daniel Jefferson Muir, San Carlos, CA (US)

(73) Assignee: Atieva, Inc., Menlo Park, CA (US)

(21) Appl. No.: 15/333,390

(22) Filed: Oct. 25, 2016

(51) Int. Cl. B29C 65/16; B29C 65/48; B29C 65/00; B32B 7/12; B32B 37/06; B32B 37/12; B32B 15/04; B32B 15/18; B32B 15/20

(52) U.S. Cl. CPC B29C 65/16; B29L 2031/30; B29C 65/1645; B29C 66/21; B29C 66/1122; B29C 66/836; B29C 66/721; B32B 7/12; B32B 37/06; B32B 37/1207; B32B 15/043; B32B 15/18; B32B 15/20; B32B 37/1292; B32B 2605/00; B29C 65/4835

(57) ABSTRACT

A method of assembling a vehicle structure is provided in which a laser system is used to expedite adhesive curing at a plurality of locations within an adhesive layer, where the adhesive layer bonds a first vehicle component to a second vehicle component. Once cured by laser irradiation and heating, the localized adhesive regions maintain the relative positions of the first and second vehicle components without the aid of a curing fixture, even though the remaining areas of the adhesive layer are uncured. This approach to tacking vehicle components together can be used to decrease fabrication time and cost.

### FIELD OF THE INVENTION

The present invention relates generally to vehicles and, more particularly, to a vehicle manufacturing process that can be used to decrease fabrication time and cost when bonding assembly techniques are used in the vehicle fabrication process.

### BACKGROUND OF THE INVENTION

Vehicle manufacturers are continually looking for ways to lower overall vehicle cost while improving vehicle characteristics. One such way that has been identified in recent years is the use of structural adhesives. Bonding components and structures together during vehicle manufacturing offer a number of advantages over traditional vehicle fabrication techniques, identified advantages including:
Lower fabrication costs: The use of structural adhesives can be used to expedite assembly, for example by eliminating steps that may be required when using a conventional assembly technique. By increasing assembly line throughput, a lower cost per vehicle can be achieved.
Decreased assembly weight: Rivets, bolts and other mechanical fasteners weigh more than adhesives. Therefore significant weight savings can be achieved by replacing conventional fasteners, to the extent possible, with structural adhesives. Lowering vehicle weight, in turn, leads to improved mileage (or mpg equivalent), thereby lowering vehicle emissions, decreasing vehicle operating costs, and increasing driving range, this last parameter being especially important for an electric vehicle where achieving what is perceived to be an adequate driving range is critical in order to gain wide-spread user acceptance.
Elimination/minimization of localized stress points: Localized stress points often arise when two structures are held together by a series of rivets, bolts, spot welds, or similar fastening means. These localized stress points, which can lead to premature component/assembly failure, can be minimized if not altogether eliminated through the use of bonding techniques in which the adhesive is distributed over a relatively large area.
Improved cosmetics: The use of structural adhesives permits two surfaces to be held together without the need for rivets, bolts or other fasteners that may disrupt an otherwise smooth surface. As a result, it is easier to maintain a cosmetically appealing surface and overall design.
Noise reduction: When in use, vehicles are constantly vibrating due to varying road conditions (e.g., course and uneven road surfaces), weather conditions (e.g., wind and rain), driving conditions (e.g., stop and go traffic, cornering at various speeds) and drive train vibrations. These vibrations cause noise (e.g., squeaks and rattles) to be generated as surfaces, especially metal surfaces, rub together. Surfaces and/or assemblies that are held together with mechanical fasteners are prone to this type of noise generation, especially as the fasteners age and become loose. Vehicle manufacturers have found that noise generation in a car can be significantly reduced by bonding these same structures and surfaces together, rather than using mechanical fasteners, due to a reduction in surface-to-surface rubbing as well as the sound deadening qualities of many types of adhesive.

While most car makers appreciate the advantages offered by structural adhesives and therefore have started to modify their manufacturing procedures in order to utilize structure adhesives to a greater extent, further improvements are still needed. The present invention provides a manufacturing process improvement that further simplifies the use of structural adhesives during the vehicle assembly process while minimizing the use of mechanical fasteners.

### SUMMARY OF THE INVENTION

The present invention provides a method of assembling a vehicle structure, where the vehicle structure is comprised of at least a first component and a second component, the method comprising the steps of (i) applying a layer of a structural adhesive onto at least one surface of a pair of surfaces, where a first surface of the pair of surfaces corresponds to a first region of the first component, and where a second surface of the pair of surfaces corresponds to a second region of the second component; (ii) aligning the first region of the first component with the second region of the second component; (iii) applying pressure to the vehicle structure, the pressure joining the first region of the first component to the second region of the second component, where the layer of structural adhesive is interposed between the first region of the first component and the second region of the second component; (iv) maintaining a position of the first component relative to the second component with a curing fixture, where the position results from the step of applying pressure to the vehicle structure to join the first region of the first component to the second region of the second component; (v) directing a laser beam at a plurality of localized regions of the vehicle structure, where the laser beam irradiates and heats the plurality of localized regions to a temperature above an ambient temperature, where the laser beam expedites curing of a plurality of adhesive regions proximate to the plurality of localized regions, and where the plurality of adhesive regions comprise a portion of the layer of structural adhesive; and (vi) removing the vehicle structure from the curing fixture after the step of directing the laser beam at the plurality of localized regions, where the step of removing the vehicle structure from the curing fixture is performed prior to curing the layer of structural adhesive, and where the plurality of adhesive regions continues to maintain the position of the first component relative to the second component after the vehicle structure is removed from the curing fixture. The vehicle structure may be placed into a curing oven after it has been removed from the curing fixture, where the curing oven heats the vehicle structure in order to complete curing of the structural adhesive layer. Additional fabrication and assembly procedures may be performed on the vehicle structure after it has been removed from the curing fixture but before it is placed into the curing oven. The laser beam may be directed sequentially or simultaneously at the plurality of localized regions.

In another aspect of the method, the laser beam may be optically split into a first beam and a second beam, where the first laser beam is directed at the plurality of localized regions and the second laser beam is directed at a second plurality of localized regions, and where the first laser beam irradiates and heats the plurality of localized regions and the second laser beam irradiates and heats the second plurality of localized regions. The second plurality of localized regions may be proximate to the plurality of adhesive regions. The plurality of localized regions may be located on the front surface of the first component, where the front surface is distal from the first surface of the first component and the front surface is separated from the first surface by a first material width corresponding to the thickness of the first component, and the second plurality of localized regions may be located on the rear surface of the second component, where the rear surface is distal from the second surface of the second component and is separated from the second surface by a second material width corresponding to the thickness of the second component. Alternately, the plurality of localized regions may be located on the front surface of the first component, where the front surface is distal from the first surface of the first component and the front surface is separated from the first surface by a first material width corresponding to the thickness of the first component, and the second plurality of localized regions may be located on the second surface of the second component, where the second plurality of localized regions is adjacent to the second region of the second component.

In another aspect of the method, a second laser beam may be directed at a second plurality of localized regions, where the second laser beam irradiates and heats the second plurality of localized regions. The second plurality of localized regions may be proximate to the plurality of adhesive regions. The plurality of localized regions may be located on the front surface of the first component, where the front surface is distal from the first surface of the first component and the front surface is separated from the first surface by a first material width corresponding to the thickness of the first component, and the second plurality of localized regions may be located on the rear surface of the second component, where the rear surface is distal from the second surface of the second component and is separated from the second surface by a second material width corresponding to the thickness of the second component. Alternately, the plurality of localized regions may be located on the front surface of the first component, where the front surface is distal from the first surface of the first component and the front surface is separated from the first surface by a first material width corresponding to the thickness of the first component, and the second plurality of localized regions may be located on the second surface of the second component, where the second plurality of localized regions is adjacent to the second region of the second component.

In another aspect of the method, the laser beam may be directed through an aperture in a third component prior to irradiating and heating at least one of the plurality of localized regions of the vehicle structure, where the third component may be an additional component of the vehicle structure.

In another aspect of the method, at least one of the pair of surfaces may be pretreated prior to applying the layer of structural adhesive.

In another aspect of the method, the laser beam may be directed at the plurality of localized regions as the vehicle structure moves relative to the laser beam thereby causing the laser beam to sequentially irradiate and heat the plurality of localized regions; alternately, the laser beam may be directed at the plurality of localized regions as the laser beam moves relative to the vehicle structure thereby causing the laser beam to sequentially irradiate and heat the plurality of localized regions.

A further understanding of the nature and advantages of the present invention may be realized by reference to the remaining portions of the specification and the drawings.

### BRIEF DESCRIPTION OF THE DRAWINGS

It should be understood that the accompanying figures are only meant to illustrate, not limit, the scope of the invention and should not be considered to be to scale. Additionally, the same reference label on different figures should be understood to refer to the same component or a component of similar functionality.

FIG. 1 highlights the primary processing steps used in the fabrication process of the present invention;

FIG. 2 schematically illustrates an assembly system in accordance with the invention;

FIG. 3 illustrates the localized regions within the adhesive layer that have been cured using the assembly system shown in FIG. 2;

FIG. 4 illustrates the localized regions within the adhesive layer that have been cured when operating the laser in a continuous or semi-continuous mode;

FIG. 5 provides a simplified schematic of an embodiment in which multiple lasers are used to simultaneously irradiate and heat multiple localized regions on a bonded structure;

FIG. 6 provides a simplified schematic of an embodiment in which the beam emanating from a single laser is split into multiple beams, thereby allowing multiple localized regions to be simultaneously irradiated and heated;

FIG. 7 provides a simplified schematic of an embodiment in which the beam emanating from a single laser is split into two beams, thereby allowing each localized adhesive region to be simultaneously heated by two different laser beams directed at two different regions of the bonded assembly;

FIG. 8 provides a simplified schematic of an embodiment in which two different lasers simultaneously heat two different regions of the bonded assembly, both affecting the same localized adhesive regions;

FIG. 9 provides a simplified schematic of an alternate embodiment using two different lasers, one beam directed at the front surface of the front component of the bonded structure and the other beam directed at the front surface of the rear component of the bonded structure, where the second beam indirectly heats the adhesive layer;

FIG. 10 provides a detailed orthogonal view of the configuration shown in FIG. 9;

FIG. 11 provides a simplified schematic of an embodiment similar to that of FIG. 9, except that a single laser source is used; and

FIG. 12 provides a simplified schematic of an embodiment similar to that of FIG. 2, except that the laser beam passes through an aperture in a third component prior to impinging on the structure to be irradiated.

### DESCRIPTION OF THE SPECIFIC EMBODIMENTS

As used herein, the singular forms “a”, “an” and “the” are intended to include the plural forms as well, unless the context clearly indicates otherwise. The terms “comprises”, “comprising”, “includes”, and/or “including”, as used herein, specify the presence of stated features, integers, steps, operations, elements, and/or components, but do not preclude the presence or addition of one or more other features, integers, steps, operations, elements, components, and/or groups thereof. As used herein, the term “and/or” and the symbol “/” are meant to include any and all combinations of one or more of the associated listed items. Additionally, while the terms first, second, etc. may be used herein to describe various steps or calculations, these steps or calculations should not be limited by these terms, rather these terms are only used to distinguish one step or calculation from another. For example, a first calculation could be termed a second calculation, similarly, a first step could be termed a second step, similarly, a first component could be termed a second component, all without departing from the scope of this disclosure.

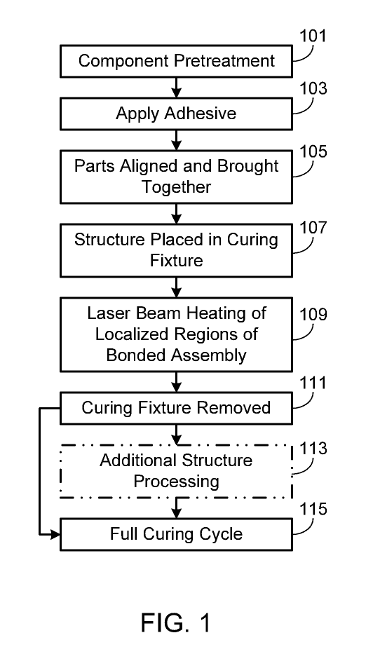

FIG. 1 highlights the primary processing steps used in the present invention. Initially, the parts to be assembled undergo a pretreatment process (step 101). It should be understood that component pretreatment is not always required. Furthermore, when component pretreatment is required, the type of pretreatment is dependent upon the materials to be bonded, the condition of those materials, and the type of structural adhesive to be used. Typical materials include a variety of metals (e.g., aluminum, steel) as well as different types of composites (e.g., high performance carbon or glass fibers contained within a matrix material such as an epoxy polymer). During the pretreatment step (step 101), the surfaces to be bonded may need to be cleaned in order to remove surface residues, oils, debris (e.g., dust) or other contaminants that could affect the ability of the structural adhesive to achieve the desired bond strength. In some instances, the pretreatment step (step 101) may involve nothing more than drying the components to be bonded. In yet other instances, the pretreatment step (step 101) may involve mechanically and/or chemically roughening one or both of the surfaces to be bonded. Surface roughening may be used to help remove surface contaminants as well as enhance bond strength by improving surface texture and increasing bond area.

After completion of any required surface pretreatment procedures, adhesive is applied to one or both of the surfaces to be bonded (step 103). The adhesive may be a single part adhesive, such as a heat curable adhesive that cures at a temperature above room temperature, or a two part adhesive, such as a two part epoxy. The layer of adhesive may be comprised solely of adhesive, or may contain a plurality of granules (e.g., spherical or non-spherical beads) that set the separation distance between the two surfaces to be bonded. If the adhesive layer contains granules, the granules may be uniformly or non-uniformly distributed throughout the adhesive layer, and may be comprised of a material selected to control heat transfer across the bond layer/joint.

After application of the adhesive, the surfaces of the two components are aligned and brought together (step 105), after which the parts are placed within a fixture (step 107), also referred to as a jig, that is configured to maintain the bonded components in their desired relative positions until the adhesive has cured, or at least until the bonded structure can be removed from the fixture and handled as described below. In some embodiments the individual components are held by different fixtures. These individual fixtures are used both to align and position the components during initial contact and to maintain the relative positions of the components throughout the curing process. In other embodiments, a first fixture(s) is used to position the components during initial contact and a second fixture(s) is used to maintain the relative positions of the parts during curing. In yet other embodiments, during initial contact the components are positioned by hand, after which they are mounted within a fixture that maintains their relative positions throughout the curing process.

In a conventional bonding process, the bonded components are held in the curing fixture throughout the entire curing process, thus significantly impacting vehicle assembly time. For some conventional applications, rather than room temperature curing the bonded components and the curing fixture are all placed within a curing oven, thereby allowing the temperature to be raised and the curing time to be decreased.

In accordance with the invention, after the parts have been bonded together and are being held together by a curing fixture, localized regions of the bonded assembly are heated using lasers (step 109). Laser heating allows small regions of the assembly to be rapidly heated to a temperature that is sufficient to either (i) completely cure the adhesive in the heated regions or (ii) cure the adhesive in the heated regions to a sufficient degree to allow handling of the assembly without further need of the curing fixture. Once localized regions of the structure have been heated, thereby curing (or partially curing) localized regions of the adhesive, the curing fixture is removed (step 111). Removal of the curing fixture at this stage, rather than after completely curing the entire layer of adhesive as required in the conventional approach, expedites vehicle assembly. Additionally, if the assembly is subsequently placed in a curing oven, for example after completion of further vehicle assembly, elimination of the curing fixture allows a smaller curing oven to be used and decreases the time required to reach the desired temperature.

Although not a requirement of the invention, typically after removal of the curing fixture (step 111), the vehicle structure will undergo further processing (step 113). As step 113 is optional, it is shown in phantom. Further processing may include attaching other components to the vehicle structure or integrating the bonded structure into another vehicle structure, where the additional processing steps may include the use of additional adhesive layers or mechanical fasteners. Further processing may also include applying surface treatments to the bonded structure, for example painting the structure. After the curing fixture has been removed (step 111), or after the curing fixture has been removed (step 111) and additional processing has been completed (step 113), the structure undergoes a complete curing cycle (step 115). This final curing cycle may be performed at room temperature, or the structure may be placed in an oven in order to heat the entire structure and expedite curing.

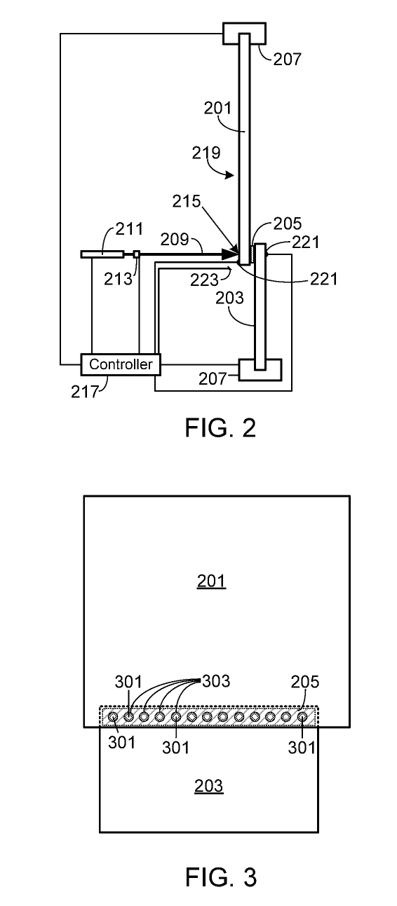

FIG. 2 schematically illustrates a preferred embodiment for a laser assisted curing system in accordance with the invention. In this figure, panels 201 and 203 represent the components that are being bonded together. Interposed between the overlapping regions of the two panels is a layer 205 of structural adhesive. Preferably adhesive layer 205 is distributed over a relatively large area between the panels to insure bond integrity and bond strength. FIG. 3 provides an orthogonal view of the two panels, this view illustrating the overlapping regions of the two panels as well as the region over which adhesive layer 205 is distributed.

In the embodiment illustrated in FIG. 2, panels 201 and 203 are held together by a curing fixture 207. As previously noted, fixture 207 may include separate fixtures for each of the components, the separate fixtures being used to hold the parts before bonding and then combined into a single fixture to hold the assembly after bonding. Alternately, fixture 207 may be a singular fixture that holds components 201 and 203 during the initial alignment and bonding steps as well as during the laser assisted curing steps. Alternately, fixture 207 may be a singular fixture into which components 201 and 203 are mounted after the initial alignment and bonding steps, but before the laser assisted curing steps.

As illustrated in FIG. 2, beam 209 from laser 211 passes through optics 213 prior to impinging on a region 215 of the assembly. Optics 213 may include beam conditioning optics (e.g., lenses, shutters, etc.) or other optical elements (e.g., mirrors, optical fibers, etc.). By moving fixture 207 along with components 201 and 203 relative to laser beam 209, or by moving laser beam 209 relative to fixture 207 and components 201 and 203, a series of small localized regions are irradiated, and thus heated, by laser 211. The orthogonal view shown in FIG. 3 illustrates this plurality of irradiated and heated regions 301. Due to the heating of regions 301 by laser 211, small regions 303 within adhesive layer 205 that are proximate to regions 301 cure at an expedited rate. The inventors have found that cured adhesive regions 303 provide sufficient strength to tack and hold components 201 and 203 together after fixture 207 has been removed, thereby allowing further assembly processing prior to curing the entire adhesive layer 205.

In the preferred and illustrated embodiment, the assembly system is automated, thereby further lowering manufacturing cost while improving quality control. In this embodiment a controller 217, typically comprised of a microprocessor or a programmable logic device, controls operation of laser 211 (i.e., laser operating characteristics such as output power, beam profile, pulse frequency, pulse duration, etc.). Preferably controller 217 also controls the locations of irradiated regions 301 by controlling the position of fixture 217, and thus components 201/203. Alternately, controller 217 may control the locations of irradiated regions 301 by controlling the location of the laser beam 209 on surface 219 of component 201. Preferably beam location is controlled by optics 213, for example using beam turning optics such as those that are well known by those of skill in the art (e.g., optical fibers, mirrors, etc.). Alternately, controller 217 may control the locations of irradiated regions 301 relative to the assembly by controlling both the location of laser beam 209 on surface 219, and the location of the assembly via fixture 207.

In order to control the heating of each region 301, thus insuring sufficient temperature and pulse duration to properly cure the adjacent adhesive region 303, controller 217 preferably monitors the output characteristics of laser 211, including output power and beam quality, as well as the thermal characteristics of each irradiated region 215. The thermal characteristics of the irradiated regions may be monitored using sensors 221 that are in thermal contact with one or both components 201 and 203. Alternately, or in combination with one or more contacting sensors, a non-contact thermal sensor(s) 223 may be used to monitor the thermal characteristics of region 215.

In general, the operating characteristics of laser 211 and laser beam 209 are selected based on the characteristics of the components to be irradiated (e.g., reflectivity, thermal conductivity, panel thickness, etc.) as well as the characteristics of the adhesive comprising layer 205 (e.g., acceptable curing temperature range, curing time versus temperature, etc.). Additionally, the initial cost, operational costs and equipment reliability are considered when selecting laser source 211. Operating characteristics that are selected based on the materials and adhesives to be bonded include the laser's wavelength, output power, pulse duration, number and frequency of pulses applied per region (e.g., region 215), beam spot size, and focal length.

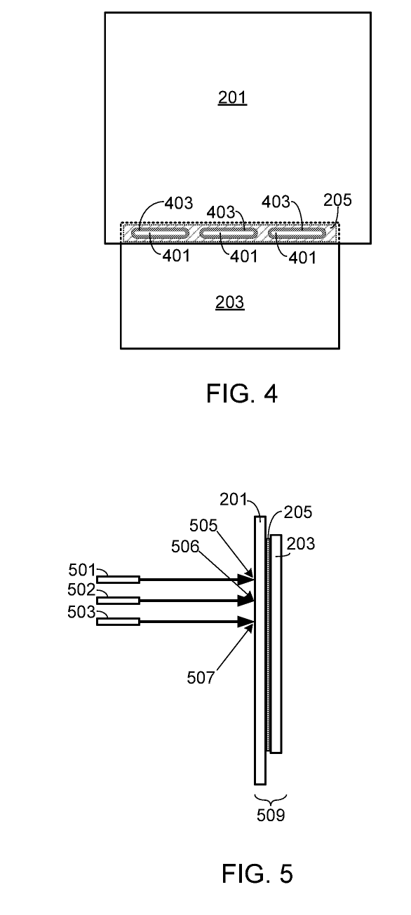

In the preferred embodiment illustrated and described above, either the bonded structure or the laser beam or both are moving while laser 211 is pulsed, thereby sequentially irradiating localized regions 301. The pulses may be generated any of a variety of ways, for example by pulsing the laser on/off or optically shuttering beam 209. In an alternate configuration, either the bonded structure or the laser beam or both move while laser 211 is operated in a continuous or semi-continuous mode. As a result, the region irradiated and heated by laser 211 is elongated, as is the region of adhesive that undergoes expedited curing. FIG. 4 provides a similar view of components 201 and 203 as shown in FIG. 3, except that the relative position of the bonded structure to the laser beam is varied during periods of time when the laser is on. As a result, both irradiated regions 401 and cured adhesive regions 403 are elongated as shown.

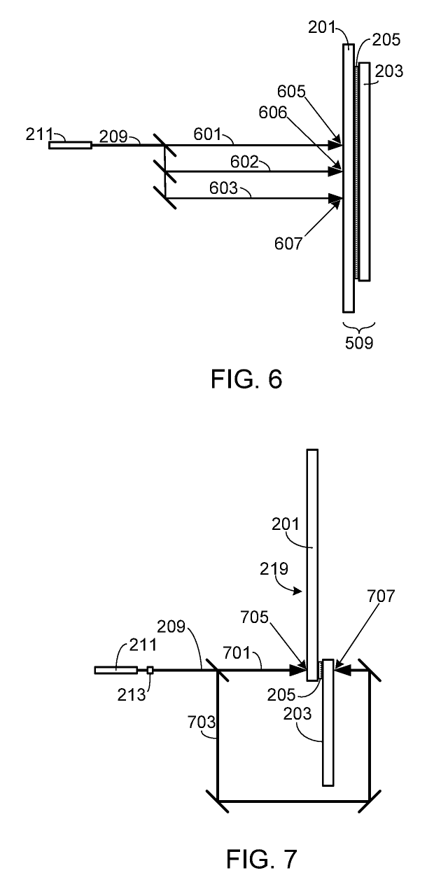

In addition to sequentially irradiating localized regions of the bonded structure, in at least one embodiment multiple localized regions are simultaneously irradiated. Simultaneous irradiation may be accomplished using multiple lasers or using a single laser in which the laser beam has been optically split into multiple beams. FIG. 5 provides a simplified schematic of an embodiment in which three lasers 501-503 are used to simultaneously irradiate three localized regions 505-507. FIG. 6 provides a simplified schematic of an embodiment in which the beam 209 emanating from laser 211 is split into three beams 601-603. As a result, each time laser 211 is pulsed, beams 601-603 will simultaneously irradiate three localized regions 605-607. Regardless of whether each set of localized regions is heated using multiple lasers or a single laser beam split into multiple beams, by moving the set of lasers/laser beams relative to bonded structure 509, or moving bonded structure 509 relative to the lasers/laser beams, multiple sets of localized regions may be sequentially irradiated thereby further expediting the assembly process.

As noted above, laser assisted curing in accordance with the invention is not limited to a single type of laser or a single set of laser operating characteristics. Additionally it should be understood that the invention is not limited to a single configuration for the beam delivery system. FIGS. 7-9, 11 and 12 illustrate alternate beam delivery system configurations, all of which achieve laser assisted curing of localized regions within the adhesive layer of a structure as previously described. While FIGS. 5-9, 11 and 12 have been simplified to insure clarity, it will be appreciated that each of these configurations may utilize a control system as described above; that each of these configurations may utilize any of a variety of curing fixture arrangements as described above; that each of these configurations may utilize a laser beam that is pulsed, continuous, or semi-continuous as described above; that each of these configurations may utilize one or multiple lasers as described above; that each of these configurations may utilize one or multiple laser beams from each laser as described above; that each of these configurations may sequentially or simultaneously irradiate the localized regions as described above; and that in each of these configurations the position of the laser beam(s) may be varied relative to the bonded structure and/or the position of the bonded structure may be varied relative to the laser beam(s) in order to cure multiple regions of the adhesive layer bonding the structure together.

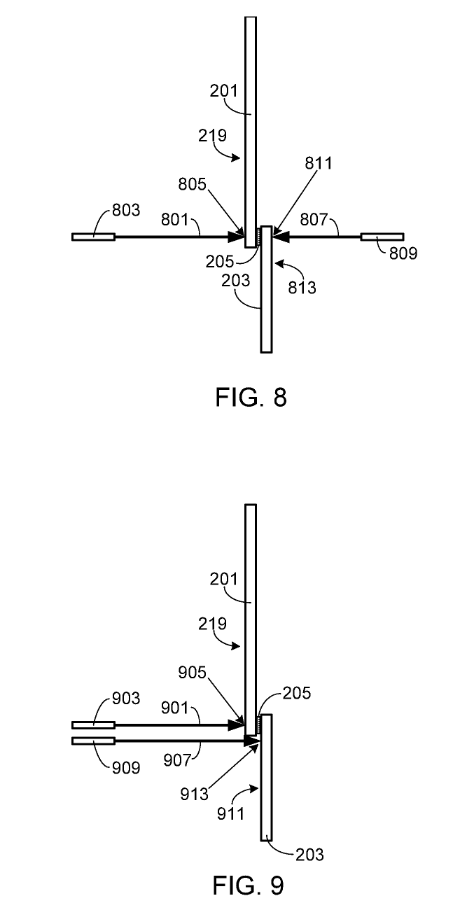

In the beam delivery system configuration illustrated in FIG. 7, laser beam 209 is split into two beams 701 and 703. Beams 701 and 703 may be configured to have the same, or different, beam profiles and intensities. By splitting laser beam 209 into two beams, each localized adhesive region is simultaneously heated by two different laser beams directed at two different regions of the bonded assembly. Thus in the configuration shown in FIG. 7, beam 701 is directed at region 705 of component 201 and beam 703 is directed at region 707 of component 203. Simultaneously irradiating and heating the same general region of the bonded assembly, but from two different directions, i.e., from the front (beam 701) and from the rear (beam 703), the corresponding region of adhesive layer 205 can be more rapidly, and in some cases more uniformly, brought to the desired curing temperature. While a single laser beam can be split into multiple beams in order to simultaneously irradiate and heat the same general region of a bonded assembly, it will be appreciated that the same effect can be achieved using multiple lasers. As shown in the exemplary configuration of FIG. 8, beam 801 from laser 803 irradiates region 805 on the front surface 219 of component 201 while beam 807 from laser 809 irradiates region 811 on the rear surface 813 of component 203. By using multiple laser sources as shown, rather than a single laser source as in the embodiment of FIG. 7, completely different laser operating characteristics can be employed, thus allowing each source to be optimized based on the material characteristics of the corresponding structure it is irradiating. Thus if component 201 is an aluminum panel and component 203 is a steel panel, the operating characteristics (e.g., wavelength, pulse duration, spot size, pulse frequency, etc.) of sources 803 and 809 can be selected based on those particular component materials. Additionally, if desired one source can initiate heating prior to the other source.

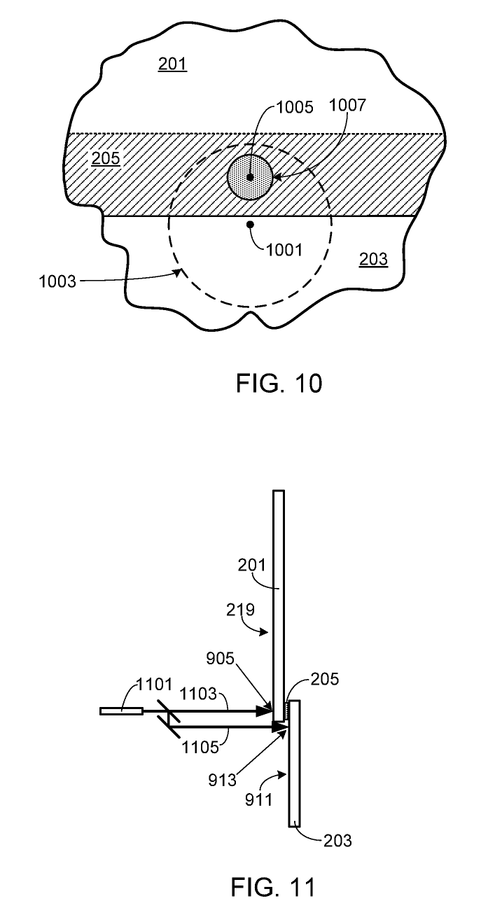

It will be appreciated that the use of multiple sources, or a single source split into multiple beams, allows other adhesive curing configurations as well. For example, in the embodiment shown in FIG. 9, beam 901 from laser source 903 is directed at region 905 of the front surface 219 of front component 201. As in the prior embodiments, this region is directly opposite from the region of the adhesive layer 205 that is to undergo rapid curing. Unlike the previous embodiments, however, a second beam 907, from laser source 909, is directed at the front surface 911 of rear component 203. Beam 907 impinges on surface 911 at a region 913 that is directly adjacent to adhesive layer 205, thus heating a region of the adhesive layer near the beam impact site. As shown in the detailed orthogonal view of FIG. 10, beam 907 is directed at a spot 1001 on surface 911 of rear component 203 that is immediately adjacent to adhesive layer 205, causing a region 1003 of component 203 and layer 205 to heat up. Beam 901, directed at spot 1005 of front component 201, further localizes the curing effects of the laser heating to a region 1007 of the adhesive layer. It will be appreciated that this same approach can be achieved using a single laser 1101 split into two beams 1103 and 1105 as shown in FIG. 11.

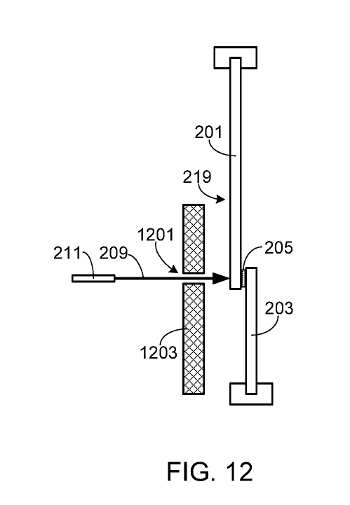

Due to the small diameter of the laser beam(s) used to augment adhesive curing, the inventors envision that the flexibility of the present invention lends itself to a variety of curing arrangements, all of which benefit from the ability to tack structures together by rapidly curing localized regions within an adhesive layer. For example, FIG. 12 illustrates an embodiment similar to that shown in FIG. 2, except that laser beam 209 passes through an aperture 1201 in a third component 1203 prior to impinging on surface 219 of component 201. Component 1203 may or may not be part of the same vehicle structure as that being bonded.

Systems and methods have been described in general terms as an aid to understanding details of the invention. In some instances, well-known structures, materials, and/or operations have not been specifically shown or described in detail to avoid obscuring aspects of the invention. In other instances, specific details have been given in order to provide a thorough understanding of the invention. One skilled in the relevant art will recognize that the invention may be embodied in other specific forms, for example to adapt to a particular system or apparatus or situation or material or component, without departing from the spirit or essential characteristics thereof. Therefore the disclosures and descriptions herein are intended to be illustrative, but not limiting, of the scope of the invention.

What is claimed is:

1. A method of assembling a vehicle structure, wherein the vehicle structure is comprised of at least a first component and a second component, the method comprising:
applying a layer of a structural adhesive onto at least one surface of a pair of surfaces, wherein a first surface of said pair of surfaces corresponds to a first region of said first component, and wherein a second surface of said pair of surfaces corresponds to a second region of said second component;
aligning said first region of said first component with said second region of said second component;
applying pressure to said vehicle structure, said pressure joining said first region of said first component to said second region of said second component, wherein said layer of structural adhesive is interposed between said first region of said first component and said second region of said second component;
maintaining a position of said first component relative to said second component with a curing fixture, wherein said position results from said step of applying pressure to said vehicle structure to join said first region of said first component to said second region of said second component;
directing a laser beam at a plurality of localized regions of said vehicle structure, wherein said laser beam irradiates and heats said plurality of localized regions to a temperature above an ambient temperature, wherein said laser beam expedites curing of a plurality of adhesive regions proximate to said plurality of localized regions, wherein said plurality of adhesive regions comprise a portion of said layer of structural adhesive; and
removing said vehicle structure from said curing fixture after said step of directing said laser beam at said plurality of localized regions, wherein said step of removing said vehicle structure from said curing fixture is performed prior to curing said layer of structural adhesive, wherein said plurality of adhesive regions continues to maintain said position of said first component relative to said second component after said vehicle structure is removed from said curing fixture.

2. The method of claim 1, further comprising:
placing said vehicle structure into a curing oven, wherein said vehicle structure is placed within said curing oven after said step of removing said vehicle structure from said curing fixture; and
heating said vehicle structure within said curing oven, wherein said heating step completes curing of said layer of structural adhesive.

3. The method of claim 2, further comprising performing additional fabrication and assembly procedures on said vehicle structure, wherein said step of performing additional fabrication and assembly procedures is performed after said step of removing said vehicle structure from said curing fixture and prior to placing said vehicle structure into said curing oven.

4. The method of claim 1, said step of directing said laser beam further comprising sequentially directing said laser beam at said plurality of localized regions of said vehicle structure.

5. The method of claim 1, said step of directing said laser beam further comprising simultaneously directing said laser beam at said plurality of localized regions of said vehicle structure.

6. The method of claim 1, said step of directing said laser beam further comprising:
optically splitting said laser beam into a first laser beam and a second laser beam, said first laser beam directed at said plurality of localized regions of said vehicle structure, wherein said first laser beam irradiates and heats said plurality of localized regions; and
directing said second laser beam at a second plurality of localized regions of said vehicle structure, wherein said second laser beam irradiates and heats said second plurality of localized regions and expedites curing of said plurality of adhesive regions.

7. The method of claim 6, said plurality of adhesive regions proximate to said second plurality of localized regions.

8. The method of claim 6, said plurality of localized regions located on a front surface of said first component, said front surface distal from said first surface of said first component, wherein said front surface is separated from said first surface by a first material width corresponding to a first component thickness, said second plurality of localized regions located on a rear surface of said second component, said rear surface distal from said second surface of said second component, wherein said rear surface is separated from said second surface by a second material width corresponding to a second component thickness.

9. The method of claim 6, said plurality of localized regions located on a front surface of said first component, said front surface distal from said first surface of said first component, wherein said front surface is separated from said first surface by a first material width corresponding to a first component thickness, said second plurality of localized regions located on said second surface of said second component, and said second plurality of localized regions located adjacent to said second region of said second component.

10. The method of claim 1, further comprising directing a second laser beam at a second plurality of localized regions of said vehicle structure, wherein said second laser beam irradiates and heats said second plurality of localized regions and expedites curing of said plurality of adhesive regions.

11. The method of claim 10, said plurality of adhesive regions proximate to said second plurality of localized regions.

12. The method of claim 10, said plurality of localized regions located on a front surface of said first component, said front surface distal from said first surface of said first component, wherein said front surface is separated from said first surface by a first material width corresponding to a first component thickness, said second plurality of localized regions located on a rear surface of said second component, said rear surface distal from said second surface of said second component, wherein said rear surface is separated from said second surface by a second material width corresponding to a second component thickness.

13. The method of claim 10, said plurality of localized regions located on a front surface of said first component, said front surface distal from said first surface of said first component, wherein said front surface is separated from said first surface by a first material width corresponding to a first component thickness, said second plurality of localized regions located on said second surface of said second component, and said second plurality of localized regions located adjacent to said second region of said second component.

14. The method of claim 1, said step of directing said laser beam further comprising directing said laser beam through an aperture in a third component prior to irradiating and heating at least one of said plurality of localized regions of said vehicle structure, wherein said vehicle structure is further comprised of said third component.

15. The method of claim 1, further comprising pretreating at least one surface of said pair of surfaces prior to said step of applying said layer of said structural adhesive.

16. The method of claim 1, said step of directing said laser beam further comprising:
maintaining said laser beam in a stationary position;
moving said vehicle structure relative to said laser beam; and
sequentially irradiating and heating said plurality of localized regions with said laser beam.

17. The method of claim 1, said step of directing said laser beam further comprising:
maintaining said vehicle structure in a stationary position;
moving said laser beam relative to said vehicle structure; and
sequentially irradiating and heating said plurality of localized regions with said laser beam.
